(19) United States
(12) Patent Application Publication
(10) Pub. No.: US 2002/0064419 A1
(43) Pub. Date: May 30, 2002

(54) Joint for ball-bearing control

(75) Inventor: Jacques Agostini, Montgeron (FR)

Correspondence Address: Martin B. Pavane, Esq., Cohen, Pontani, Lieberman & Pavane, Suite 1210, 551 Fifth Avenue, New York, NY, 10176, US

(73) Assignee: Constructions Brevetees D'Alfortville CBA

(21) Appl. No.: 09/988,864

(22) Filed: Nov. 19, 2001

(30) Foreign Application Priority Data
Nov. 24, 2000 (FR) 0015180

(51) Int. Cl. F16D 1/12; F16C 11/00

(52) U.S. Cl. 403/122

(57) ABSTRACT

This invention relates to a joint for passage through a wall by a ball-bearing control cable comprising in particular an elemenr longitudinally mobile in a guiding tube, characterized in that it comprises:

a nut provided with an axial cavity presenting spherical walls opening out in a divergent bore made inside a threaded sleeve extending said nut and intended to pass through the wall,

a ring in the form of a portion of ball adapted to rotate freely in all directions within said cavity of the nut in contact with its spherical wall and intended to be removably fixed to the guiding tube, and

a lock-nut intended to be screwed on said sleeve on that side of the wall opposite the nut.

### FIELD OF THE INVENTION

The present invention relates to a joint for passage through a wall by a ball-bearing control.

### BACKGROUND OF THE INVENTION

Ball-bearing controls comprise in particular a longitudinally mobile element in contact with balls between two lateral rails fixed inside a metal sheath.

Its three-dimensional radii of curvature derive from the bending and torsion of all its components.

However, for passages through walls, the control is connected on either side of the wall to connectors, while its structure is reduced, over the short section of passage, to the element and to an outer guiding tube.

The freedom of clearance of the guiding tube is ensured by means of a ball-joint fast with said tube and housed in a base allowing fixation on the wall around the orifice for passage.

However, for placing this base, holes must be pierced in the wall in the vicinity of the orifice, this fragilizing the wall and is therefore incompatible with the requirements of certain work specifications in particular in the aeronautical domain.

In addition, the conventional control cables are equipped with a ball-joint extended forwardly by a section of guiding tube. However, the structure of this joint does not allow the addition of a rear section of tube, which is absolutely necessary for a ball-bearing control in order to guarantee the axial alignment of the element in the tube on either side of the wall.

This ball joint is therefore unsuitable for ball-bearing controls.

Moreover, in the presence of a passage through a wall, it proves impossible to replace a conventional control cable by a ball-bearing control, as the element on its own does not have flexibility in all planes, or especially in its own plane, unlike a cable.

It is an object of the present invention to overcome the technical problems set forth hereinabove.

### SUMMARY OF THE INVENTION

This object is attained, according to the invention, by means of a joint, characterized in that it comprises:

a nut provided with an axial cavity presenting spherical walls opening out in a divergent bore made inside a threaded sleeve extending said nut and intended to pass through the wall,

a ring in the form of a portion of ball adapted to rotate freely in all directions within said cavity of the nut in contact with its spherical wall and intended to be removably fixed to the guiding tube, and

a lock-nut intended to be screwed on said sleeve on that side of the wall opposite the nut.

According to an advantageous characteristic, the guiding tube is constituted by two sections of which the respective ends are intended to be assembled coaxially with each other inside the ring.

According to a first embodiment, the two sections are intended to be screwed in each other while tightening said ring.

According to another embodiment, said ring is tapped and the two sections are threaded and intended to be screwed in said ring.

According to another characteristic, said ring comprises a throat forming stop for a flange borne by the guiding tube.

According to a further characteristic, said cavity of the nut comprises two diametrally opposite lateral notches, of which the angular length is slightly greater than the width of the ring so as to allow extraction thereof in a plane perpendicular to that of the nut.

The guiding tube is preferably provided, on its lateral wall, with at least two diametrally opposite flat parts allowing it to be gripped with a view to being fixed to the ring.

According to another characteristic, said nut comprises an annular shoulder defining a face for blocking coming into abutment against said wall.

According to a specific variant, the respective outer lateral edges of the cavity of the nut and of the bore of the sleeve are bevelled in order to increase the limiting angle of clearance of the guiding tube.

In the presence of a single orifice for passage through the wall, the joint of the invention makes it possible to mount a ball-bearing control without restriction of the clearance of the element and, if necessary, to replace a conventional cable control without weakening the wall.

### BRIEF DESCRIPTION OF THE DRAWINGS

The invention will be more readily understood on reading the following description with reference to the accompanying drawings in which:

FIG. 1 shows a view in section of an embodiment of the joint of the invention, with the element in axial position.

FIG. 2 shows a view in section of the joint of FIG. 1, with the element in inclined position.

### DESCRIPTION OF PREFERRED EMBODIMENT

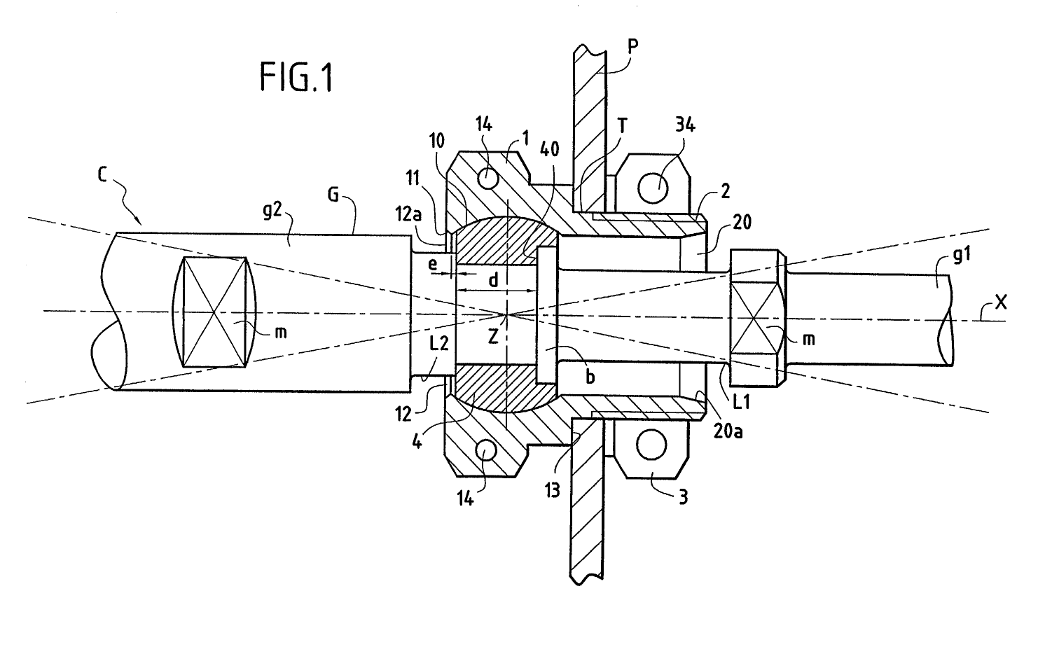

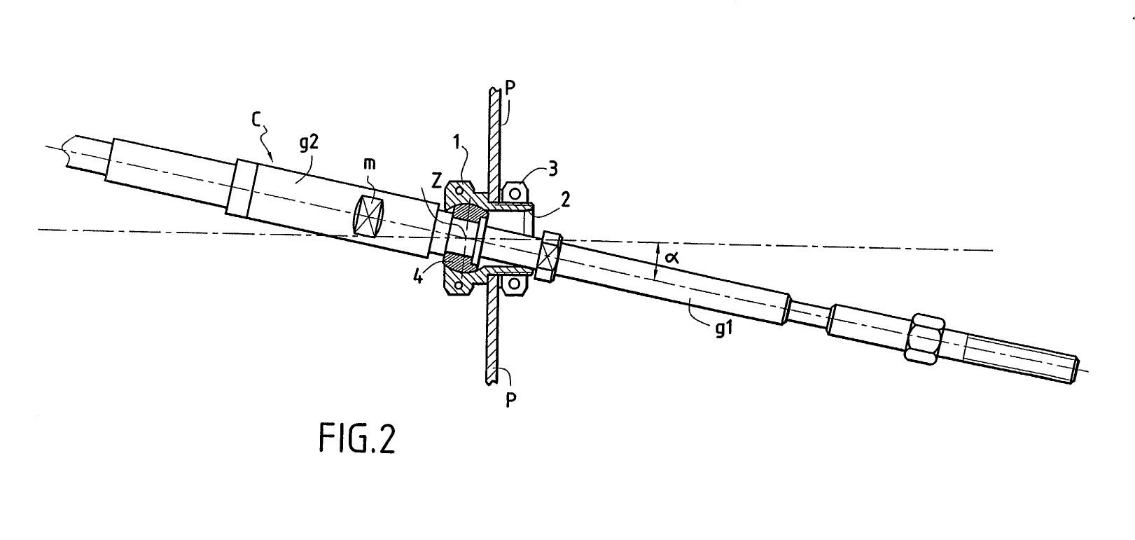

Referring now to the drawings, the joint shown in FIGS. 1 and 2 is intended to equip a ball-bearing control C to allow it to pass, via an orifice T, though a wall P.

In FIG. 1, the ball-bearing control C is shown only partially in the form of the short section traversing the wall, which is interposed between the sheath connectors and aligned on axis X. The central element which is longitudinally mobile is not visible, since it is enclosed inside the guiding tube G.

The joint of the invention comprises a nut 1 extended by a threaded sleeve 2 intended to pass through the wall P, being housed in orifice T.

A lock-nut 3 is screwed on the sleeve 2 on that side of the wall P opposite the nut 1 in order to ensure fixation of the joint. The nut 1 comprises to that end an annular shoulder 13 defining a face for blocking coming into abutment against the wall P.

The nut 1 is internally provided with an axial cavity 10 with spherical walls.

The cavity 10 opens out in a divergent bore 20 made inside the sleeve 2.

The cavity 10 receives a ring 4 in the form of a portion of ball whose dimensions are such as to allow free rotation of said ring in all directions, in contact with the spherical wall, in the manner of a bearing.

Furthermore, the ring 4 is removably fixed to the guiding tube G.

In the embodiment shown in the Figures, the guiding tube G is constituted by two sections g1, g2 of which the respective ends are intended to be assembled coaxially with each other inside the central orifice of the ring 4 of one of the sections, for example section g2.

To that end, an end portion is provided with a tapping in which a threaded end portion of the section g1 is screwed, tightening the ring 4 in interposed manner.

In the present case, the tapped and threaded end portions present a length d less than the width of the ring 4 since the ring 4 comprises a throat 40 forming stop for a flange b borne by the threaded portion of the section g1 of the guiding tube G.

As for section g2, it bears a shoulder e coming into abutment against the thickness of the ring 4 at the end of screwing of section g1.

The ring 4 is thus immobilized between the flange b and the shoulder e.

According to another embodiment (not shown), the ring 4 is tapped and the two sections g1, g2 are threaded in order to be screwed in said ring.

The cavity 10 of the nut 1 comprises two diametrally opposite lateral notches 11, 12 whose angular length is slightly greater than the width of the ring 4 so as to allow extraction thereof in a plane perpendicular to the plane of the nut 1.

The guiding tube G is provided, on its lateral wall, with at least two and, in the present case, four flat parts m diametrally opposite in two's.

The flat parts m allow the sections g1, g2 of the tube to be gripped by a clamping tool for the purpose of assembly thereof and fixation to the ring 4.

In the embodiment shown, the nut 1 and the lock-nut 3 comprise transverse conduits 14, 34 for the installation of anti-rotation links (not shown).

The guiding tube G may have clearance in all directions up to a limiting angle α of pivoting shown in FIG. 2 and which, in this case, has a value of about 45°.

The pivot axis passes through the centre Z of the ring 4 which is here located to the rear of the wall P.

The necks L1, L2 of incurved section which are formed on the sections g1, g2 of the guiding tube G respectively come into abutment against the divergent outer edge 20a of the bore 20 and the outer lateral edge 10a of the cavity 10, which are both bevelled and thus increase the extreme value of the limiting angle α.

What is claimed is:

1. Joint for passage through a wall by a ball-bearing control cable comprising in particular an elemenr longitudinally mobile in a guiding tube,
wherein it comprises:
a nut provided with an axial cavity presenting spherical walls opening out in a divergent bore made inside a threaded sleeve extending said nut and intended to pass through the wall,
a ring in the form of a portion of ball adapted to rotate freely in all directions within said cavity of the nut in contact with its spherical wall and intended to be removably fixed to the guiding tube which is constituted by two sections of which the respective ends are adapted to be assembled coaxially with each other inside the ring, and
a lock-nut intended to be screwed on said sleeve on that side of the wall opposite the nut.

2. The joint of claim 1, wherein the two sections are intended to be screwed in each other, while tightening said ring.

3. The joint of claim 1, wherein said ring is tapped and the two sections are threaded and intended to be screwed in said ring.

4. The joint of claim 1, wherein said ring comprises a throat forming stop for a flange borne by the guiding tube.

5. The joint of claim 1, wherein said cavity of the nut comprises two diametrally opposite lateral notches, of which the angular length is slightly greater than the width of the ring so as to allow extraction thereof in a plane perpendicular to that of the nut.

6. The joint of claim 1, wherein the guiding tube is provided, on its lateral wall, with at least two diametrally opposite flat parts allowing it to be gripped with a view to being fixed to the ring.

7. The joint of claim 1, wherein said nut comprises an annular shoulder defining a face for blocking coming into abutment against said wall.

8. The joint of claim 1, wherein the respective outer lateral edges of the cavity of the nut and of the bore of the sleeve are bevelled in order to increase the limiting angle of clearance of the guiding tube.
